(19) United States
(12) Patent Application Publication
(10) Pub. No.: US 2005/0171790 A1
(43) Pub. Date: Aug. 4, 2005

(54) Construction project management system and method

(76) Inventor: Theodore Thomas Blackmon, San Jose, CA (US)

Correspondence Address: CARR & FERRELL LLP, 2200 GENG ROAD, PALO ALTO, CA, 94303, US

(21) Appl. No.: 10/768,758

(22) Filed: Jan. 30, 2004

(51) Int. Cl. G06F 17/60

(52) U.S. Cl. 705/1; 705/8

(57) ABSTRACT

A construction project management system generates a computerized simulation model of a construction project based on data accessed in project databases. The system maps engineering data into constructible elements in the computerized simulation model based on manufacturing data and organizes the constructible elements by construction crafts, construction areas, and systems for testing and turnover. Additionally, the system matches the constructible elements with one or more work steps based on project controls data and generates a visual display of the construction project. A user selects construction areas in the visual display of the construction project and selects constructible elements within the construction areas, via a graphical user interface of the system, to create work packages for work crews. Each work package comprises work steps for the constructible elements in the work package, and can include an estimated time and cost for executing the work steps in the work package.

### BACKGROUND

1. Field of the Invention

The present invention relates generally to project management, and more particularly to a computerized system and method of managing a construction project.

2. Background Art

A construction project often has a plurality of databases, which are accessed during management of the construction project. For example, a construction project may include an engineering database, a materials management system (MMS) database, a project management database, a manufacturing database and a project controls database. The engineering database may contain engineering data, such a three-dimensional (3D) computer-aided design (CAD) models for project materials and the spatial layout of the project materials in the construction project. The MMS database may contain data for procuring project materials (e.g., purchase orders and vendors information) and status information for the project materials (e.g., expected delivery dates, actual delivery dates and location of the project materials at the construction site). The project management database may contain a project schedule, which includes activities that are to be completed for the construction project. The manufacturing database may contain information for fabricating the project materials and building the construction project with the project materials. The project controls databases may contain data for estimating the time and costs of completing the construction project.

In one approach to construction project management, a project manager manually creates construction tasks for work crews based on data accessed in various project databases of a construction project. For example, a project manager can manually create a construction task for installing a particular project material at the construction site based on data accessed in a 3D CAD model of the particular project material in an engineering database, a project schedule in a project management database and a delivery schedule of the particular project material in an MMS database. The manual creation of construction tasks in this manner can be tedious and time consuming.

In some instances, a project manager may not take project constraints into account when creating construction tasks. For example, a construction task may require the use of shared site equipment or may depend upon the completion of another construction task. As a result of these project constraints, a work crew may not be able to efficiently execute the construction task. Moreover, the constraints for the construction task may change after creation of the construction task, which may result in further inefficiencies in executing the construction task.

In light of the above, there exists a need for a system and method of efficient project management.

### SUMMARY OF THE INVENTION

The present invention addresses the need for efficient project management by providing a system and method of generating a computerized simulation model of the project. Although the present invention will be discussed in terms of construction project management, principles of the present invention are applicable to other types of project management.

In the present invention, a computerized simulation model is generated for a construction project based on engineering data of the construction project. The computerized simulation model represents project materials and the spatial relationships between the project materials in the construction project. In the computerized simulation model, the project materials are mapped into constructible elements based on manufacturing data of the construction project. Additionally, in the computer simulation model, the constructible elements are organized by construction crafts, construction areas and systems, based on project management data. A visual display (e.g., an interactive 3D graphical display) of the computerized simulation model is generated, which allows a user to view the construction areas and constructible elements in the computerized simulation model.

A user selects a construction area and constructible elements within the construction area in the visual display of the computerized simulation model via a graphical user interface to create work packages. Work steps are determined for the constructible elements (e.g., for installing, fabricating or testing the constructible elements in the construction project) in the work packages, based on project controls data. Additionally, time and cost estimates are determined for completing the work packages, based on project controls data.

A user selects work packages in the visual display of the computerized simulation model via the graphical user interface to sequence the work packages and assign the work packages to work crews. Additionally, a user can validate the work packages based on project constraints (e.g., project materials and site equipment availability), modify the work packages, reassign the work packages and reprioritize the sequence of the work packages. A user selects work packages in the visual display of the computerized simulation model and releases the selected work packages to work crews, via the graphical user interface. The user can monitor the status of the construction project by viewing the visual display of the computerized simulation model.

In a method in accordance with the present invention, a simulation model of a construction project is generated based on design data of the construction project. The computerized simulation model includes a representation of the project materials and the spatial relationships between the project materials in the construction project. In the computerized simulation model, the project materials are mapped into constructible elements, based on manufacturing data of the construction project. One or more work steps are identified for each constructible element based on project controls data of the construction project. One or more constructible elements are selected to create a work package based on user input. The work package contains the selected constructible elements and the work steps identified for the selected constructible elements.

In a system in accordance with the present invention, a project design module generates a computerized simulation model of a construction project based on design data of the construction project. The computerized simulation model includes a representation of project materials and the spatial relationship of the project materials in the construction project. A mapping module maps the project materials of the construction project into constructible elements based on manufacturing data of the construction project. A task detailing module determines work steps for the constructible elements based on the project controls data of the construction project. A work packaging module generates work packages containing selected constructible elements and work steps for the selected constructible elements, based on user input.

In a computer program product in accordance with the present invention, computer program code comprises steps for generating a simulation model of a construction project based on design data of the construction project. The computerized simulation model includes a representation of the project materials and the spatial relationships between the project materials in the construction project. The computer program product further comprises computer program steps for mapping the project materials represented in the computerized simulation model into constructible elements based on manufacturing data of the construction project. Furthermore, the computer program product comprises computer program steps for determining one or more work steps for each constructible element based on project controls data of the construction project. The computer program product also includes computer program steps for selecting one or more constructible elements to create a work package, based on user input. The work package contains the selected constructible elements and the work steps identified for the selected constructible elements.

### BRIEF DESCRIPTION OF THE DRAWINGS

FIG. 1 is a block diagram of an exemplary construction management system, in accordance with one embodiment of the present invention;

FIG. 2 is a block diagram of the exemplary construction engine shown in FIG. 1;

FIG. 3 is a block diagram of the exemplary project design module shown in FIG. 2;

FIG. 4 is a block diagram of the exemplary task detailing module shown in FIG. 2;

FIG. 5A is a block diagram of the exemplary work packaging module shown in FIG. 2;

FIG. 5B is a block diagram of the exemplary constraints analysis module shown in FIG. 5A; and

FIG. 6 is a flowchart of an exemplary method for managing a construction project, in accordance with one embodiment of the present invention.

### DETAILED DESCRIPTION OF THE EXEMPLARY EMBODIMENTS

In accordance with the present invention, a computerized simulation model of a construction project is generated based on data contained in various project databases of the construction project. The computerized simulation model includes a representation of project materials and the spatial relationship between the project materials in the construction project. In the computerized simulation model, the project materials are mapped into constructible elements based on manufacturing data (e.g., fabrication and construction documents) accessed in the various project databases and work steps are identified for each constructible element based on projects controls data (e.g., a library of standard work steps) accessed in the various project databases. A user selects constructible elements in a visual display (e.g., interactive 3D graphical display) of the computer simulation model via a graphical user interface to create a work package. The computerized simulation model automatically generates a time and cost estimate for the work package based on project controls data (e.g., a library of unit time rates and unit cost rates) accessed in the various project databases.

A user can use the computerized simulation model to create multiple work packages, sequence the work packages and assign the work packages to work crews, via the graphical user interface. Additionally, a user can use the computerized simulation model to validate the work packages against project constraints, modify the work packages and reprioritize the sequence of the work packages before releasing the work packages to work crews, via the graphical user interface. A user can track and monitor the status of work package execution by viewing the visual display of the computerized simulation model.

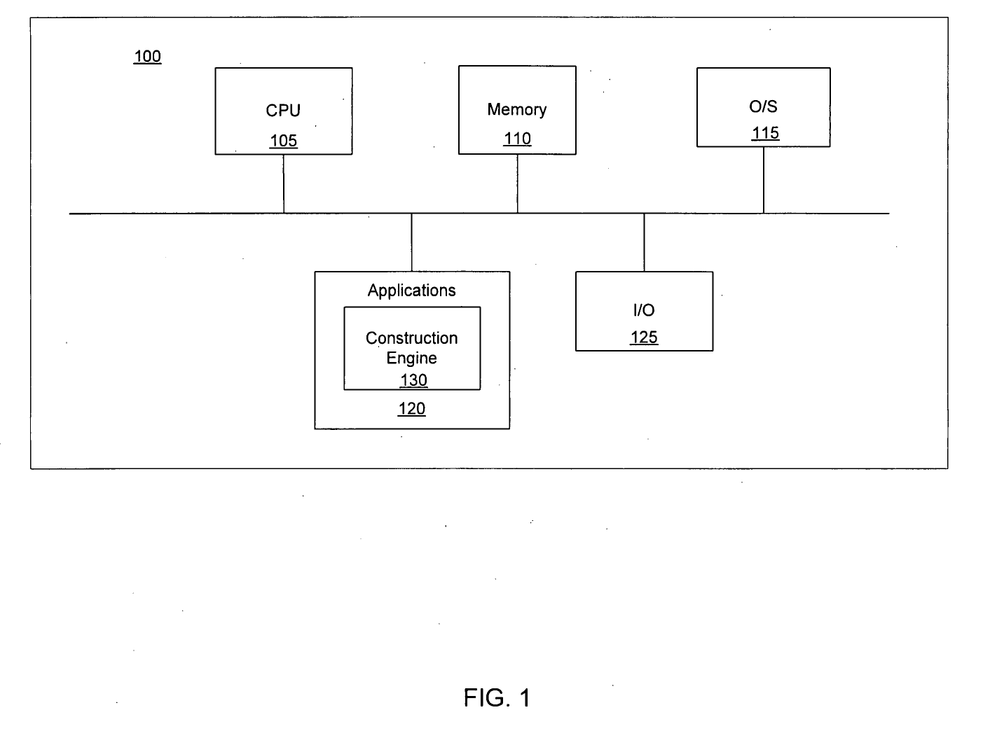

Referring to FIG. 1, an exemplary construction project management system 100 is shown. The exemplary system 100 comprises a computer processor unit (CPU) 105, a memory device 110, an operating system 115, applications 120 and input-output devices 125, which are electronically coupled to each other for communication. The applications 120 further comprise a construction engine 130 that allows a user to manage (e.g., estimate, plan, schedule, track, optimize and monitor) a construction project, as is described more fully herein. The input-output devices 125 comprise an interface that allows the construction engine 130 to access one or more databases (not shown), as is described more fully herein. For example, the databases may comprise engineering databases (e.g., an AutoCAD database), materials management systems (MMS) databases (e.g., an Oracle database), project management databases (e.g., a Primavera P3E/C database), manufacturing databases (e.g., an ISOGEN piping isometrics database), and project controls databases (e.g., an MS Access database). In one embodiment, the databases are external to the system 100. In an alternative embodiment, the databases are located within the system 100. In still another embodiment, some of the databases are external to the system and other databases are located within the system 100.

According to one embodiment of the present invention, the system 100 works within a distributed computing network in which the system 100 operates together with other similar systems to allow a user to manage the construction project. In this embodiment, the processing work is thus shared among the plurality of systems 100, which communicate via the input-output devices 125. Alternatively, the single system 100 may perform all the processing.

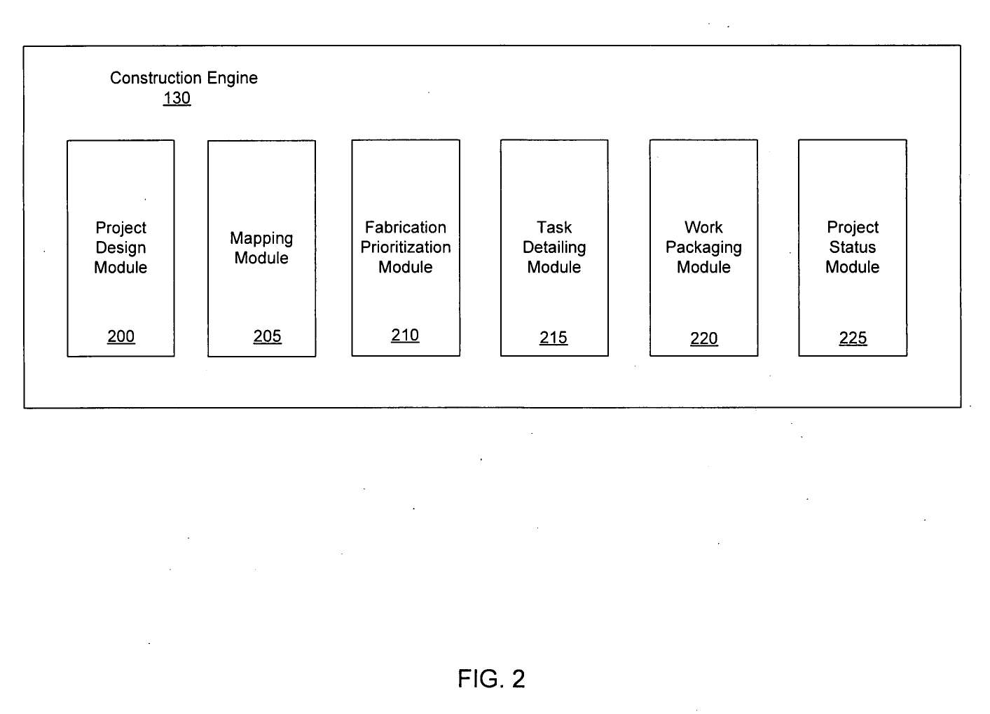

Referring now to FIG. 2, an exemplary embodiment of the construction engine 130 is shown. The construction engine 130 may comprise one or more user interfaces (not shown) to allow a user to operate the system 100 (FIG. 1). Additionally, the exemplary construction engine 130 comprises a project design model 200, a mapping module 205, a fabrication prioritization module 210, a task detailing module 215, a work packaging module 220 and a project status module 225. The various modules work in conjunction with each other to allow a user to manage the construction project. FIG. 2 illustrates one embodiment of the construction engine 130. Alternative embodiments may comprise less, more, or other modules for managing and simulation a construction project.

The exemplary project design module 200 generates a computerized simulation model of the construction project based on data in various project databases for the construction project. Additionally, the project design module 200 organizes the data in the computerized simulation model according to construction crafts (e.g., plumbing), construction areas (e.g., physical work areas) and systems (e.g., components grouped together for testing and turnover to operations) based on data in the project databases. The computerized simulation model represents the project materials and the spatial relationship of the project materials to each other in the construction project.

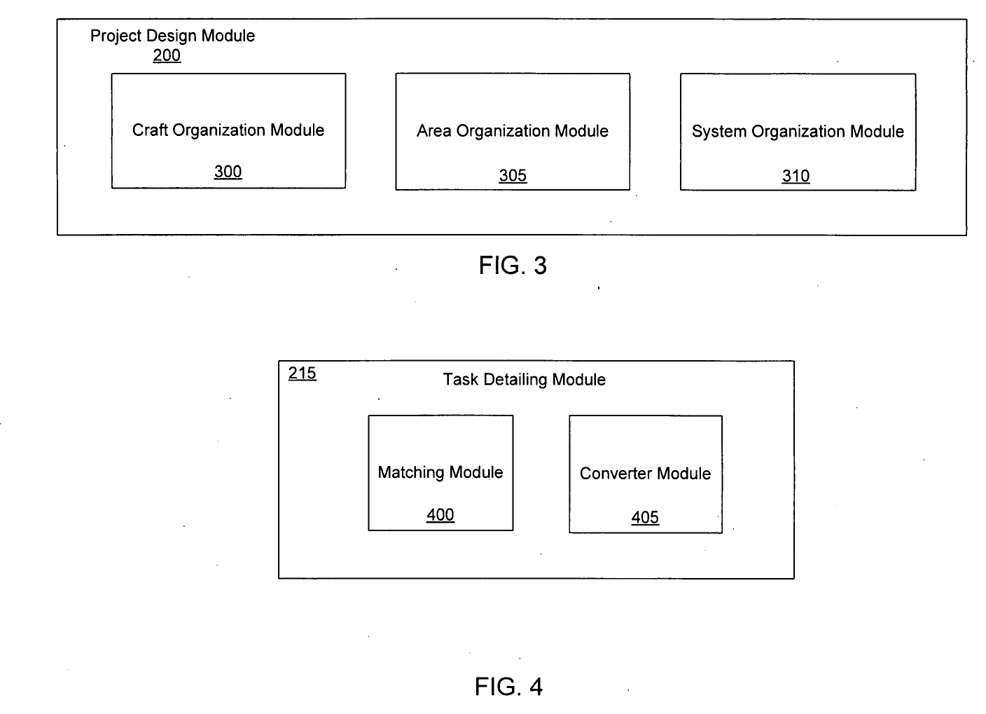

In one embodiment, the project design module accesses engineering data (e.g., a 3D CAD model of the construction project) in an engineering database to generate the computerized simulation model. In a further embodiment, the project design module 200 accesses a project schedule in a project schedule database to define construction crafts (e.g., trades and skills), construction areas (e.g., physical work areas) and systems (e.g., systems for testing and turnover) in the computerized simulation model, based on attributes in the engineering data and project schedule. The project design module 200 will be discussed in more detail in connection with FIG. 3.

The exemplary mapping module 205 maps project materials represented in the computerized simulation module into constructible elements in the computerized simulation model based on manufacturing data (e.g. fabrication documents and construction documents) accessed in the project databases. For example, the manufacturing data can comprise specific details describing how to fabricate the constructible elements and how to construct the project with the constructible elements.

In one example, the mapping module 205 maps a pipeline (e.g., a project material) in the construction project into one or more pipe spools (e.g., constructible elements) to be fabricated by a pipe fabrication shop and delivered to the construction site. Additionally, in this example, the mapping module 205 maps the pipeline into prefabricated constructible elements (e.g. field materials), such as standard valves, gaskets, and bolts, to be purchased and delivered to the construction site. In another example, the mapping module 205 maps the design data for a plurality of steel beams (e.g., project materials) in the construction project into a structural frame (e.g., constructible element) to be fabricated by a steel fabrication shop and delivered to the construction site.

In one embodiment, the mapping module 205 generates a visual display of the constructible elements for a mapped project material. In this embodiment, the mapping module 205 visually displays the constructible elements as 3D objects that are selectable by user via a graphical user interface. In a further embodiment, the mapping module graphically displays a list of the fabrication documents, a list of the construction documents, and a list of project materials for the selected constructible elements.

The exemplary fabrication prioritization module 210 prioritizes, monitors, tracks and visually displays the procurement status of constructible elements for the construction project, as is described more fully herein. In one embodiment, the fabrication prioritization module 210 determines the procurement priority (e.g., fabrication priority) of constructible elements based on “just-in-time” or “lean construction” supply chain methods, as would be appreciated by those skilled in the art. In another embodiment, the fabrication prioritization module 210 generates an ordering schedule (e.g., fabrication prioritization document) based on target installation data (e.g., target installation dates) for the constructible elements. Thus, the fabrication prioritization module 210 provides an order to procure (e.g., fabricate) constructible elements.

In one embodiment, the fabrication prioritization module 210 associates the constructible elements of the construction project with activities in the project schedule based on the organization of the constructible elements by construction crafts and construction areas in the computerized simulation model. In this embodiment, the fabrication prioritization module 210 determines the desired order to procure (e.g., fabricate) constructible elements based on the order of activities in the project schedule.

In another embodiment, the fabrication prioritization module 210 associates constructible elements with work packages. In this embodiment, the order to procure (e.g., fabricate) constructible elements in the work packages is based on the sequence of work packages to be released to construction crews, as is described more fully herein.

The exemplary task detailing module 215 performs detailed quantification and estimation of work steps to be executed in the construction project. In one embodiment, the task detailing module 215 generates a plurality of work steps for the constructible elements in the computerized simulation model. Additionally, in this embodiment, the task detailing module 215 estimates the time and cost associated with each of the work steps in the work package. In a further embodiment, the task detailing module 215 accesses data in one or more databases to determine the work steps (e.g., typical work steps) to be executed for a given type of constructible element. In this embodiment, the task detailing module 215 accesses data (e.g., unit time rate or unit cost rate) in one or more databases to estimate the time and cost of executing the work steps for a constructible element based upon one or more units of measure (e.g., length, size or weight) of the constructible element. Additionally, the task detailing module 215 associates each work step to an activity in the project schedule. The task detailing module 215 will be discussed in more detail in connection with FIG. 4.

The exemplary work packaging module 220 allows a user to interactively select and group constructible elements into work packages via a user interface. For example, a user can create a work package that has a specific number of work units (e.g., hours, days or weeks) for a particular work crew. In one embodiment, the work packaging module 220 comprises a graphical user interface that allows a user to point-and-click on constructible elements in a visual display (e.g., interactive 3D computer display) of the computerized simulation model to select and group the constructible elements into a work package. Additionally, the work packaging module 220 allows the user to monitor characteristics of the work package (e.g., estimated cost and time of work steps) as the work package is being created. In this way, the user can customize the work packages for specific work crews and evenly distribute the work packages to different work crews.

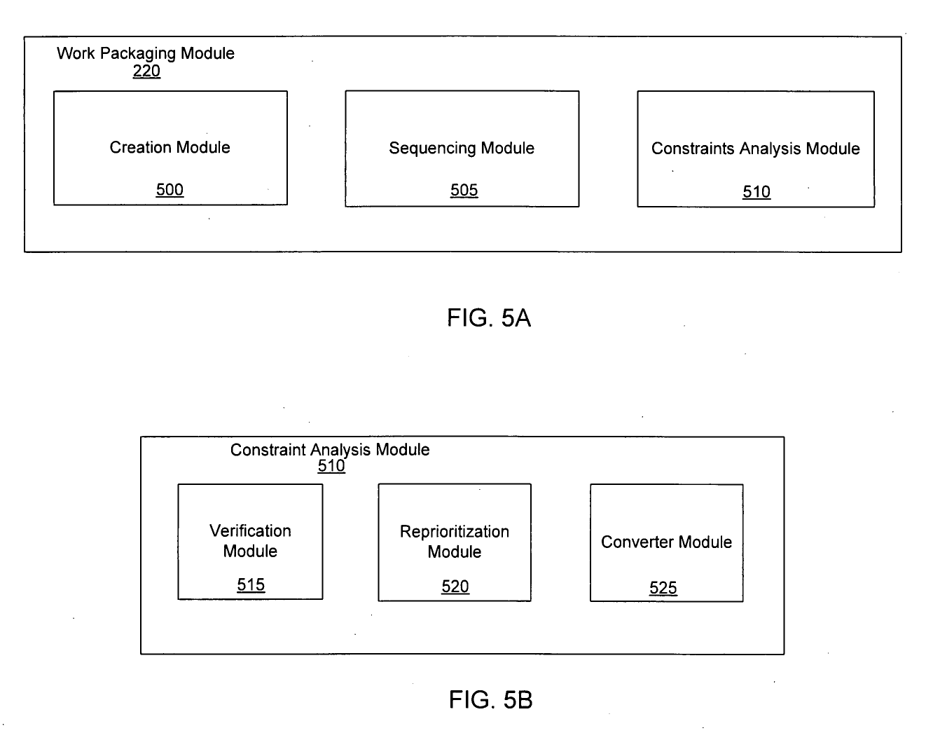

The work packaging module 220 also allows a user to build a sequence of work packages and to assign the work packages to the work crews. Additionally, the work packaging module 220 allows a user to validate the work packages based on project constraints (e.g., project materials and site equipment availability), modify the work packages, reassign the work packages to different work crews and reprioritize the sequence of the work package. The work packaging module 220 will be discussed in more detail in connection with FIGS. 5A and 5B.

The exemplary project status module 225 generates a visual display of the computerized simulation model that allows a user to monitor the construction status of the construction project. Additionally, the project status module 225 generates a visual display comparing the actual construction status to the expected construction status according to the project schedule. In one embodiment, the project status module 225 allows a user to input status information on the construction project to the system 100 (FIG. 1) or network. Based on this status information, the project status module 225 visually displays work that has been completed on the construction project (e.g., constructible elements that have been installed, work steps that have been executed, and work packages that have been executed) and work that remains to be completed on the construction project. In the visual display, the project status module 225 colors the constructible elements associated with work that has been completed with a different color from those constructible elements associated with work that remains to be completed. In yet a further embodiment, the project status module 225 works in conjunction with the task detailing module 215 and the work packaging module 220 to visually identify constraints (e.g., dependencies) for the constructible elements. For example, the project status module 225 can generate a display of the remaining constructible elements to be installed in a system prior to testing of that system.

Referring now to FIG. 3, the exemplary project design model 200 is shown in more detail. The exemplary project design model 200 comprises a craft organization module 300, an area organization module 305 and a system organization module 310. The craft organization module 300 organizes project materials represented in the computerized simulation model according to construction crafts (e.g., piping, structural, mechanical equipment, electrical work, etc.). In one embodiment, the craft organization module 300 accesses data in the project databases (e.g., project schedule and fabrication documents) to determine construction crafts in the construction project. In another embodiment, the craft organization module 305 comprises a user interface that allows a user to define construction crafts and to associate constructible elements with construction crafts.

In another embodiment, the craft organization module 300 comprises a user interface (e.g., graphical user interface) that allows a user to retrieve data associated with a specific construction craft and a specific contractor or project participant based on data in the project databases and information supplied by a user via the user interface. For example, the data associated with a specific construction craft of a specific contractor can comprise engineering data for constructible elements in the construction project.

The area organization module 305 organizes constructible elements in the computerized simulation model into construction areas based on data accessed in the project databases (e.g., engineering data, project management data and manufacturing data). A given construction area in the computerized simulation model may comprise one or more constructible elements generated by the exemplary mapping module 205 or no constructible elements (i.e., an empty construction area). For example, a construction area may be a room on a building floor that comprises portions of an electrical system and portions of a plumbing system. As another example, a constructible area may be a three-dimensional workspace (e.g., floor area by floor height) within the construction project. In one embodiment, the area organization module 305 accesses the project schedule in a project schedule database and determines the construction areas based on the project schedule.

In another embodiment, the area organization module 305 generates a visual display (e.g., an interactive 3D visual display) of the computerized simulation model that allows a user to interactively define the constructible areas via a user interface (e.g., graphical user interface). In this embodiment, the user can define the physical boundaries of each construction area by defining the geometric borders of the constructible areas in the visual display. Further, in this embodiment, a user can define rules for the constructible areas. For example, a user can define precedence rules for constructible elements in overlapping constructible areas to associate these constructible elements with one of the overlapping constructible areas.

The exemplary system organization module 310 organizes constructible elements in the computerized simulation model into systems for testing and turnover based on data accessed in the project databases (e.g., engineering data, project management data and manufacturing data). A system may comprise constructible elements from multiple crafts and may span across multiple construction areas. For example, a system may be a hot water supply system that is to be completed during the mechanical completion phase of the construction project. In this example, the piping and electrical heater must be installed prior to testing and turnover of the hot water supply system. Accordingly, the system organization module 310 organizes the constructible elements associated with the piping and electrical heater into a system.

In one embodiment, the system organization module 310 organizes constructible elements in the computerized simulation model into systems based on attributes in an engineering CAD model accessed in an engineering database. In another embodiment, the system organization module 310 organizes project materials represented in the computerized simulation model based on process and instrumentation diagrams accessed in other engineering databases (e.g., equipment lists and line lists). In a further embodiment, the system organization module 310 may comprise a user interface (e.g., graphical user interface) to allow a user to define systems and to select and group constructible elements into systems.

Referring now to FIG. 4, the exemplary task detailing module 215 is shown: The exemplary task detailing module 215 comprises a matching module 400 and a converter module 405. The matching module 400 determines one or more work steps for each constructible element based on data in the project databases (e.g., a library of standard work steps in a project controls database). In one embodiment, the work steps are standard work steps for installing constructible elements into a construction project, as would be appreciated by one skilled in the art. In another embodiment, the work steps are customized work steps contained in a company's proprietary database for installing constructible elements into a construction project. Thus, output of the matching module 400 may comprise a plurality of detailed work steps (e.g., 25,000 work steps) which may be used by the system 100 (FIG. 1) to track the progress of construction.

For example, a constructible element can be a pipe spool that is part of a pipe line (e.g., project material), and the work steps determined for this constructible element may comprise: (1) receive the pipe from the pipe fabricator; (2) place the pipe into position; (3) weld the pipe to adjoining pipes; (4) test the operation of the pipe; and (5) restore the pipe for mechanical completion and system turnover. In this example, the level of detail contained in the steps for installing the pipe is targeted for a work crew. In contrast to this low level of detail, the project schedule typically contains activities at a much higher level of detail. For example, an activity in the project schedule can be to install all pipes that are to be located in the first floor of a building.

Additionally, the matching module 400 associates work steps matched with the constructible elements to an activity in the project schedule. Further, the work packaging module 220 (FIG. 2) can use the work steps for a given constructible element to create work packages, as is described more fully herein.

In one embodiment, the matching module 400 accesses data in the databases that comprises unit time rates and unit cost rates of executing the work steps for constructible elements. In one embodiment, the unit time rates and unit cost rates are based on characteristics of the constructible elements (e.g., length, size or weight). In this embodiment, the matching module 400 determines unit time rates and unit cost rates for the constructible elements in the computerized simulation model. Accordingly, the matching module 400 matches constructible elements with work steps, a unit time rate, and a unit cost rate, based on characteristics of the constructible elements.

Because the task detailing module 215 may access data (e.g., work steps, unit time rates, and unit cost rates) in a company's proprietary databases, a mechanism for conversion within the system 100 may be needed. The exemplary converter module 405 converts data accessed in the company's proprietary databases into a common format for use in the matching module 400. In one embodiment, the converter module 405 also converts data generated by the matching module 400 into appropriate formats for storage in the company's proprietary databases. Accordingly, the matching module 400 via the conversion module 405 can use data accessed in one company's proprietary databases to produce data that can be stored in another company's proprietary databases. Thus, various users (e.g., companies) may utilize their own standards and databases in the system 100 without modification and without public disclosure of proprietary information in the standards or databases. It is to be understood that the converter module 405 is optional in the present embodiment.

Referring now to FIG. 5A, an exemplary work packaging module 220 is shown. The exemplary work packaging module 220 comprises a creation module 500, a sequencing module 505 and a constraints analysis module 510. The creation module 500 allows a user to interactively create a work package in the computerized simulation model via a user interface. In one embodiment, the creation module 500 generates a visual display (e.g., interactive 3D graphical display) of the computerized simulation model that is navigable via a graphical user interface. In this embodiment, a user selects a construction area created by the project planning module 200 (FIG. 2) by entering a construction area in the visual display of the computerized simulation model. Additionally, in this embodiment, the user selects a work package type (e.g., fabrication, erection, or test) and selects and groups constructible elements within the construction area, via the graphical user interface, to create work packages. For example, the graphical user interface can include a computer mouse and the user can point-and-click on a construction area in the visual display of the construction project using the computer mouse to select the construction area. Further, in this example, the user can point-and-click on constructible elements in the visual display using the computer mouse to select and group the constructible elements into work packages.

Additionally, the creation module 500 incorporates the work steps generated by the task detailing module 215 (FIG. 2) for constructible elements in a work package into the work package. In one embodiment, the creation module 500 calculates and displays an estimate of the time for completing the work steps in a work package as the work package is being created, which allows the user to customize the size (e.g., the estimated time for completing the work steps) of the work package. Further, the user can select and deselect constructible elements in the visual display via a graphical user interface to evaluate various combinations of constructible elements before finalizing the work package with the desired set of constructible elements. Accordingly, the user can customize the size of a work package (e.g., estimated time for the work package) for a specific crew to evenly distribute work among the work crews. Moreover, a user can create optimal work packages for various work crews.

The exemplary sequencing module 505 allows a user to sequence work packages, and to assign and release work packages to work crews. In one embodiment, a user can interactively select a work crew and one or more work packages in the visual display of the computerized simulation model via a graphical user interface to assign the work packages to the work crew. For example, the user can assign work packages to a work crew for a particular week. In a further embodiment, the sequencing module 505 generates a visual display (e.g., interactive 3D graphical display) of work packages and work crews that allows a user to visually see the assignment of work packages to work crews. In this embodiment, the sequencing module 505 displays the work packages in a different color for each work crew to allow the user to identify work packages assigned to a given work crew.

The sequencing module 505 also allows a user to release the work packages to work crews. For example, a user can release work packages to work crews after validating the work packages by using the constraints analysis module 510, as is described more fully herein. In one embodiment, a user selects work packages in a visual display of the computerized simulation model via a graphical user interface to release the work packages to a work crew. In one embodiment, the sequencing module 505 causes a document containing works steps for the released work package to be printed so that the document can be distributed to the work crew for execution.

The constraints analysis module 510 determines whether a work package is valid by evaluating project constraints for the work package (e.g., availability of project materials, site space, work crews and site equipment at the proposed time of release to a work crew). Additionally, the constraints analysis module 510 works with the creation module 500 to allow a user to modify work packages and with the sequencing module 505 to allow a user to modify the sequence of work packages. Thus, the constraints analysis module 510 evaluates constraints on a given work package to allow a user to determine whether to release the work package to a work crew.

Referring now to FIG. 5B, an exemplary embodiment of the constraints analysis module 510 is shown. The exemplary constraints analysis module 510 comprises a verification module 515, a reprioritization module 520 and a converter module 525. The verification module 515 analyzes resource constraints (e.g., availability of constructible elements) associated with a work package to determine whether a work crew can execute the work package subject to the constraints. If the verification module 515 determines that the work crew can complete the work package subject to the constraints, the verification module 515 validates the work package. For example, the verification module 515 can access data in the databases to verify that the pipe spools and standard pipe valves (e.g., constructible elements) in the work package are present on the construction site so that a work crew can execute the work package.

The reprioritization module 520 allows a user to reprioritize the sequence (e.g., scheduled release) of work packages. In one embodiment, the reprioritization module 520 automatically identifies the constructible elements that have not been installed for a given system (e.g., water supply system) and reprioritizes the sequence of the work packages to facilitate the completion of the given system. For example, the reprioritization module 520 can identify work packages for installing a particular system for testing and turnover and can modify the sequence to prioritize release of the identified work packages. The user can then release the reprioritized work packages to work crews by using the sequencing module 505 (FIG. 5). In one embodiment, the reprioritization module 520 is part of the sequencing module 505. In an alternative embodiment, the reprioritization module 520 works in conjunction with the creation module 500 and sequencing module 505 to reprioritize work steps across multiple work packages. In this embodiment, the reprioritization module 520 and creation module 500 can create new work packages to replace the multiple work packages.

Because the constraints analysis module 510 may access data in a company's proprietary databases (e.g., an MMS database), a mechanism for conversion within the constraints analysis module 510 may be needed. The exemplary converter module 525 converts data accessed in the company's proprietary databases into a common format for use in the constraints analysis module 510. In one embodiment, the converter module 525 also converts data generated by the constraints analysis module 510 into appropriate formats for storage in the proprietary databases. Accordingly, the constraints analysis module 510 via the conversion module 525 can use data accessed in one company's proprietary databases to produce data that can be stored in another company's proprietary databases. Thus, various users (e.g., companies) may utilize their own standards and databases without modification and without public disclosure of proprietary information in the standards and databases. It is to be understood that the converter module 525 is optional in the present embodiment.

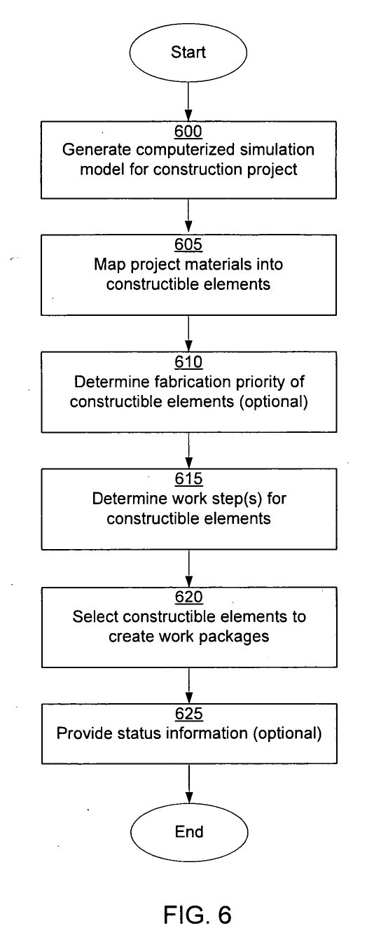

Referring now to FIG. 6, a flowchart of an exemplary method for tracking and simulating a construction project in the system 100 is shown. In step 600, the project design module 200 (FIG. 2) accesses engineering data (e.g., engineering CAD model of the construction project) in the project databases and generates a computerized simulation model of the construction project based on the engineering data. The computerized simulation model represents the project materials and the spatial relationship between the project materials in the construction project. In one embodiment, the project design model 200 accesses the engineering data in an engineering database via the input-output device 125 (FIG. 1) and stores the data in the memory device 110 (FIG. 1).

According to exemplary embodiments, the project design module 200 accesses a project schedule in a project management database. In this embodiment, the project design module 200 defines construction crafts, construction areas and systems in the computerized simulation model based on attributes of the engineering data and the project schedule.

In step 605, mapping module 205 (FIG. 2) maps project materials represented in the computerized simulation model into constructible elements in the computerized simulation model based on manufacturing data (e.g., fabrication and construction documents) accessed in a project database. For example, a constructible element can be a fabricated pipe spool or a standard valve.

In optional step 610, the fabrication prioritization module 210 (FIG. 2) determines the procurement (e.g., fabrication) priority of constructible elements. In one embodiment, the fabrication prioritization module 210 creates an ordering schedule (e.g., a fabrication prioritization document) based on target installation data (e.g., target installation dates) for each constructible element in the computerized simulation model. In a further embodiment, the fabrication prioritization module 210 prioritizes the procurement of constructible elements based on “just-in-time” or “lean construction” supply chain methods, as would be appreciated by those skilled in the art. It is to be understood that step 610 may be performed as a later step in the exemplary method illustrated by the flowchart.

In step 615, the matching module 400 of the task detailing module 215 (FIG. 2) determines work steps for the constructible elements and generates an estimate of the time and cost for performing the work steps. In one embodiment, the task detailing module 215 accesses the work steps, unit time rates and unit cost rates in a project controls database via the input-output device 125 (FIG. 1). In this embodiment, the project controls database comprises standard steps that are typically executed for a constructible element, a unit time rate for executing the work steps (e.g., installation time required per length of pipe) and a unit cost rate for executing the work steps (e.g., cost per unit length of pipe). In a further embodiment, the converter module 405 of the task detailing module 215 converts data accessed in a user's (e.g., company's) proprietary database for use by the task detailing module 215. Similarly, the converter module 405 converts data generated by the matching module 400 for use in the user's (e.g., company's) proprietary database.

In step 620, the work packaging module 220 (FIG. 2) generates work packages for the construction project, based on user input. In one embodiment, a user can select a construction area in a visual display of the computerized simulation model, via a graphical user interface. Additionally, the user can select a type of work package (e.g., fabrication, erection, or test), and constructible elements in the selected construction area, via the graphical user interface, to group these constructible elements. Conversely, the user can deselect a constructible element to remove that constructible element from the group. Once the user is satisfied with the grouping of the constructible elements, the user can create a work package comprising the selected constructible elements. Also in step 620, the user can control the execution of the constraints analysis module 510 (FIG. 5) via the graphical user interface to validate work packages, modify work packages, and reprioritize the sequence of the work packages for release to work crews. Additionally, the user can control the execution of the sequencing module 505 (FIG. 5) via the graphical user interface to release the work packages to work crews.

In optional step 625, the project status module 225 (FIG. 2) provides status information for the construction project. For example, the project status module 225 can provide status information based on the execution status of work packages. According to one embodiment, the project status module 225 generates a visual display (e.g., interactive 3D graphical display) of the work that has been completed (e.g., work packages that have been executed) and the work that is to be completed for the construction project. In another embodiment, a user can enter information into the system 100 (FIG. 1) or network as the construction project progresses. The information is then used to update the computerized simulation model in real time, for instance. In a further embodiment, the project status module 225 can compare the work actually completed to the work project schedule and generate a multimedia display showing the sequence of work actually completed over time (i.e., a 4D simulation of construction). In still another embodiment, the project status module 225 displays the computerized simulation model of the construction project during creation of work packages.

The exemplary embodiments discussed herein are illustrative of the present invention. Various modifications or adaptations of the methods and/or specific structures described may become apparent to those skilled in the art. All such modifications, adaptations or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A method for managing a construction project comprising:
generating a computerized simulation model for the construction project representing project materials in the construction project;
mapping the project materials represented in the computerized simulation model into constructible elements;
determining at least one work step for each constructible element; and
selecting at least one constructible element to create a work package comprising the at least one constructible element and the at least one work step for the at least one constructible element.

2. The method of claim 1, further comprising organizing the constructible elements into construction areas in the computerized simulation model.

3. The method of claim 1, further comprising organizing the constructible elements into construction crafts in the computerized simulation model.

4. The method of claim 1, further comprising organizing the constructible elements into systems for testing and turnover in the computerized simulation model.

5. The method of claim 1, further comprising prioritizing procurement of the constructible elements based on target installation dates of the constructible elements.

6. The method of claim 1, further comprising generating a visual display of the computerized simulation model.

7. The method of claim 1, further comprising generating an interactive three-dimensional graphical display of the computerized simulation model.

8. The method of claim 1, wherein selecting the at least one constructible element further comprises allowing a user to point-and-click on the at least one constructible element in a visual display of the computerized simulation model to select the at least one constructible element.

9. The method of claim 8, further comprising providing status information for the work package during creation of the work package.

10. The method of claim 9, wherein providing status information further comprises displaying in a visual display of the computerized simulation model work that has been completed on the construction project.

11. The method of claim 9, wherein providing status information further comprises displaying in a visual display of the computerized simulation model a time estimate for the work package.

12. The method of claim 9, wherein providing status information further comprises displaying in a visual display of the computerized simulation model a cost estimate for the work package.

13. The method of claim 1, wherein the computerized simulation model is an interactive three-dimensional computerized simulation model.

14. The method of claim 1, further comprising sequencing a plurality of work packages for release to work crews by selecting the work packages in a visual display of the computerized simulation model via a graphical user interface.

15. The method of claim 1, further comprising assigning the work package to a work crew by selecting the work packages in a visual display of the computerized simulation model via a graphical user interface.

16. The method of claim 1, further comprising:
accessing engineering data for the construction project in a database, wherein generating a computerized simulation model is based on the engineering data; and
accessing manufacturing data for the construction project in an other database, wherein mapping the project materials into constructible elements is based on the manufacturing data.

17. A system for managing a construction project comprising:
a project design module configured to generate a computerized simulation model of the construction project representing project materials in the construction project;
a mapping module configured to map the project materials represented in the computerized simulation model into constructible elements;
a task detailing module configured to determine at least one work step for each constructible element; and
a work packaging module configured to create a work package comprising at least one constructible element and the at least one work step for the at least one constructible element.

18. The system of claim 17, wherein the project design model comprises a craft organization module configured to organize the constructible elements into construction crafts in the computerized simulation model.

19. The system of claim 17, wherein the project design model comprises a construction area organization module configured to organize the constructible elements into construction areas in the computerized simulation model.

20. The system of claim 17, wherein the project design model comprises a system organization module configured to organize the constructible elements into systems for testing and turnover in the computerized simulation model.

21. The system of claim 17, further comprising a graphical user interface configured to allow a user to point-and-click on the at least one constructible element in a visual display of the computerized simulation model to select the at least one constructible element for the work package.

22. The system of claim 17, wherein the work packaging module is further configured to allow a user to point-and-click on the at least one constructible element in a visual display of the computerized simulation model to select the at least one constructible element for the work package.

23. The system of claim 22, further comprising a status module configured to provide status information for the construction project in a visual display of the computerized simulation model during creation of the work package.

24. The system of claim 23, wherein the status information comprises a time estimate for the work package.

25. The system of claim 23, wherein the status information comprises a cost estimate for the work package.

26. The system of claim 17, wherein the system is further configured to generate a visual display of the computerized simulation model.

27. The system of claim 17, wherein the system is further configured to generate an interactive three-dimensional graphical display of the computerized simulation model.

28. The system of claim 17, wherein the computerized simulation model is an interactive three-dimensional computerized simulation model.

29. The system of claim 17, wherein the work packaging module further comprises a sequencing module configured to assign a plurality of work packages to work crews and to sequence the plurality of work packages for release to work crews.

30. The system of claim 29, wherein the work packaging module further comprises a reprioritization module configured to reprioritize the sequence of the work packages.

31. The system of claim 17, wherein the work packaging module further comprises a constraints analysis module configured to determine whether the work package is valid.

32. The system of claim 17, wherein the work packaging module further comprises a verification module configured to analyze resource constraints for the construction project to determine whether a work crew can execute the work package subject to the constraints.

33. The system of claim 17, wherein the work packaging module further comprises a converter module configured to convert data accessed from an external database into a common format for use in the matching module.

34. A computer program product for managing a construction project comprising computer program code for performing the steps of:
generating a computerized simulation model of the construction project, the computerized simulation model representing project materials in the construction project;
mapping the project materials represented in the computerized simulation model into constructible elements;
determining at least one work step for each constructible element; and
selecting at least one constructible element to create a work package comprising the at least one constructible element and the work steps for the at least one constructible element.

35. The computer program product of claim 34, further comprising computer program code to generate a visual display of the computerized simulation model.

36. The computer program product of claim 34, further comprising computer program code to generate an interactive three-dimensional graphical display of the computerized simulation model.

37. The computer program product of claim 34, wherein the computerized simulation model is an interactive three-dimensional computerized simulation model.

38. The computer program product of claim 34, further comprising computer program code to allow a user to point-and-click on the at least one constructible element in a visual display of the computerized simulation model to select the at least one constructible element.

39. A system for managing a construction project comprising:
means for generating a computerized simulation model of a construction project, the computerized simulation model representing project materials in the construction project;
means for mapping the project materials represented in the computerized simulation model into at least one constructible element;
means for determining at least one work step for each constructible element; and
means for creating a work package comprising the at least one constructible element and the work steps for the at least one constructible element.

40. The system recited in claim 39, further comprising:
means for generating a visual display of the computerized simulation model.
